(19) United States
(12) Patent Application Publication
(10) Pub. No.: US 2009/0327236 A1
(43) Pub. Date: Dec. 31, 2009

(54) VISUAL QUERY SUGGESTIONS

(75) Inventors: Justin Denney, Seattle, WA (US); Timothy C. Hoad, Redmond, WA (US); Richard J. Qian, Sammamish, WA (US); Kieran Richard McDonald, Seattle, WA (US); Justin Hamilton, Redmond, WA (US)

Correspondence Address: SHOOK, HARDY & BACON L.L.P.;(c/o MICROSOFT CORPORATION), INTELLECTUAL PROPERTY DEPARTMENT, 2555 GRAND BOULEVARD, KANSAS CITY, MO, 64108-2613, US

(73) Assignee: MICROSOFT CORPORATION, Redmond, WA (US)

(21) Appl. No.: 12/163,655

(22) Filed: Jun. 27, 2008

(51) Int. Cl. G06F 17/30

(52) U.S. Cl. 707/3; 707/E17.014

(57) ABSTRACT

Systems, computer-implemented methods, and computer-readable media for presenting video search results for query suggestions are provided. A search query is received from a user. One or more query suggestions related to the search query are determined. One or more video items or images relevant to the one or more query suggestions are accessed. One or more image representations for the one or video items or images relevant to the one or more query suggestions are displayed to the user who input the original search query.

### BRIEF SUMMARY

Embodiments of the present invention relate to systems, computer-implemented methods, and computer-readable media for presenting video search results for query suggestions. A search query is received from a user. One or more query suggestions related to the search query are determined. One or more video items or images relevant to the one or more query suggestions are accessed. One or more image representations for the one or video items or images relevant to the one or more query suggestions are displayed to the user who input the original search query.

This Summary is provided to introduce a selection of concepts that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

Embodiments are described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is a flow diagram illustrating methods for displaying one or more image representations of one or more video items associated with one or more query suggestions;

FIG. 4 is an illustrative screen display of an exemplary user interface showing video query suggestion image representations in accordance with an embodiment of the present invention;

FIG. 5 is an illustrative screen display of an exemplary user interface showing selection of a video query suggestion image in accordance with an embodiment of the present invention; and

FIG. 6 is an illustrative screen display of an exemplary user interface showing selection of video query suggestion text in accordance with an embodiment of the present invention.

### DETAILED DESCRIPTION

The subject matter of embodiments of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention provide systems, methods, and computer-readable media for presenting video search results for query suggestions. A search query is received and one or more query suggestions are determined that are related to the search query. One or more video items or images relevant to the one or more query suggestions are accessed. An image representation is displayed for the one or more video items or images relevant to the one or more query suggestions to a user.

In another embodiment, one or more computer-readable media having computer-executable instructions embodied thereon for performing a method for presenting video search results for query suggestions are provided. A search query input by a user is received. One or more query suggestions related the search query are determined. A search is performed for one or more web pages containing one or more video items relevant to the one or more query suggestions. A video preview of the one or more video items is generated that may be dynamically executed in response to one or more user actions. A static image of the video preview is displayed of the one or more video items relevant to the one or more query suggestions to the user. One or more user actions are received to dynamically execute the preview of the one or more video items. The preview of the one or more video items is played in response to the one or more user actions.

In yet another embodiment, a user interface embodied on one or more computer-readable media for presenting video query suggestions in response to an input query is provided. The user interface comprises a video item query response representation display area that displays a representation of each of one or more video items. The one or more video items are search results in response to the input query and comprise a video preview. The video preview is dynamically executed within the video item representation display area in response to one or more user actions. The user interface further comprises a video item query suggestion representation display area that displays a representation of each of one or more video items for one or more query suggestions. The representation of each of the one or more video items comprises a video preview. The video preview is dynamically executed within the video item representation display area in response to one or more user actions.

Embodiments of the present invention display query suggestions to a user in the form of images and/or videos rather than or in addition to text. This allows for a user to visually scan the images more quickly than scanning text. Furthermore, displaying query suggestions in the form of images and/or videos allows the user to stay in the same mental/visual mode for processing information. For example, a user wanting to view videos will likely be able to more easily scan images of video query suggestions than a textual list. Furthermore, embodiments of the invention provide video previews of query suggestions, saving search time and making the search process more efficient for a user.

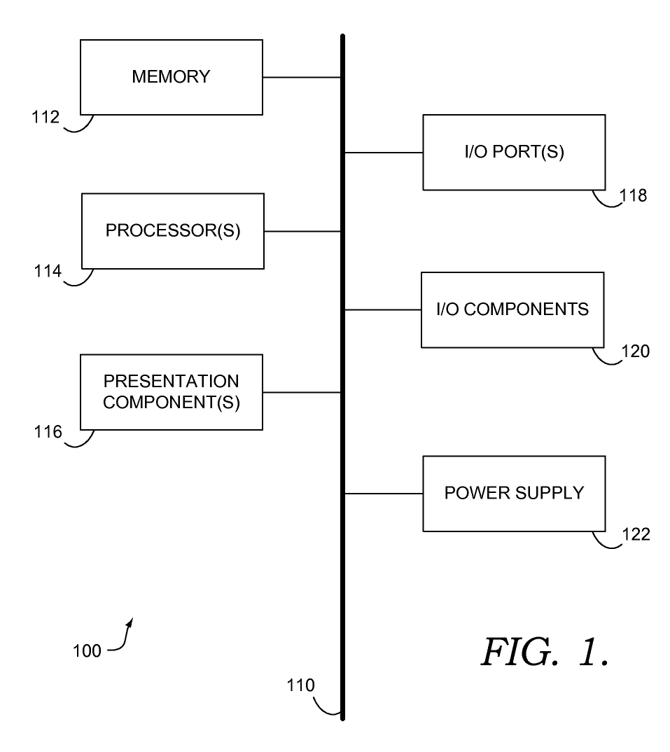

Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing environment 100 be interpreted as having any dependency or requirement relating to any one or combination of modules/modules illustrated.

Embodiments may be described in the general context of computer code or machine-useable instructions, including computer-executable instructions such as program modules, being executed by a computer or other machine, such as a personal data assistant or other handheld device. Generally, program modules including routines, programs, objects, modules, data structures, and the like, refer to code that performs particular tasks, or implement particular abstract data types. Embodiments may be practiced in a variety of system configurations, including hand-held devices, consumer electronics, general-purpose computers, specialty computing devices, etc. Embodiments may also be practiced in distributed computing environments where tasks are performed by remote-processing devices that are linked through a communications network.

With continued reference to FIG. 1, computing device 100 includes a bus 110 that directly or indirectly couples the following devices: memory 112, one or more processors 114, one or more presentation modules 116, input/output (I/O) ports 118, I/O modules 120, and an illustrative power supply 122. Bus 110 represents what may be one or more busses (such as an address bus, data bus, or combination thereof). Although the various blocks of FIG. 1 are shown with lines for the sake of clarity, in reality, delineating various modules is not so clear, and metaphorically, the lines would more accurately be grey and fuzzy. For example, one may consider a presentation module such as a display device to be an I/O module. Also, processors have memory. The inventors hereof recognize that such is the nature of the art, and reiterate that the diagram of FIG. 1 is merely illustrative of an exemplary computing device that can be used in connection with one or more embodiments. Distinction is not made between such categories as “workstation,” “server,” “laptop,” “hand-held device,” etc., as all are contemplated within the scope of FIG. 1 and reference to “computer” or “computing device.”

Computing device 100 typically includes a variety of computer-readable media. By way of example, and not limitation, computer-readable media may comprise Random Access Memory (RAM); Read Only Memory (ROM); Electronically Erasable Programmable Read Only Memory (EEPROM); flash memory or other memory technologies; CDROM, digital versatile disks (DVD) or other optical or holographic media; magnetic cassettes, magnetic tape, magnetic disk storage or other magnetic storage devices, carrier wave or any other medium that can be used to encode desired information and be accessed by computing device 100.

Memory 112 includes computer-storage media in the form of volatile and/or nonvolatile memory. The memory may be removable, non-removable, or a combination thereof. Exemplary hardware devices include solid-state memory, hard drives, optical-disc drives, etc. Computing device 100 includes one or more processors that read data from various entities such as memory 112 or I/O modules 120. Presentation module(s) 116 present data indications to a user or other device. Exemplary presentation modules include a display device, speaker, printing module, vibrating module, etc. I/O ports 118 allow computing device 100 to be logically coupled to other devices including I/O modules 120, some of which may be built in. Illustrative modules include a microphone, joystick, game pad, satellite dish, scanner, printer, wireless device, etc.

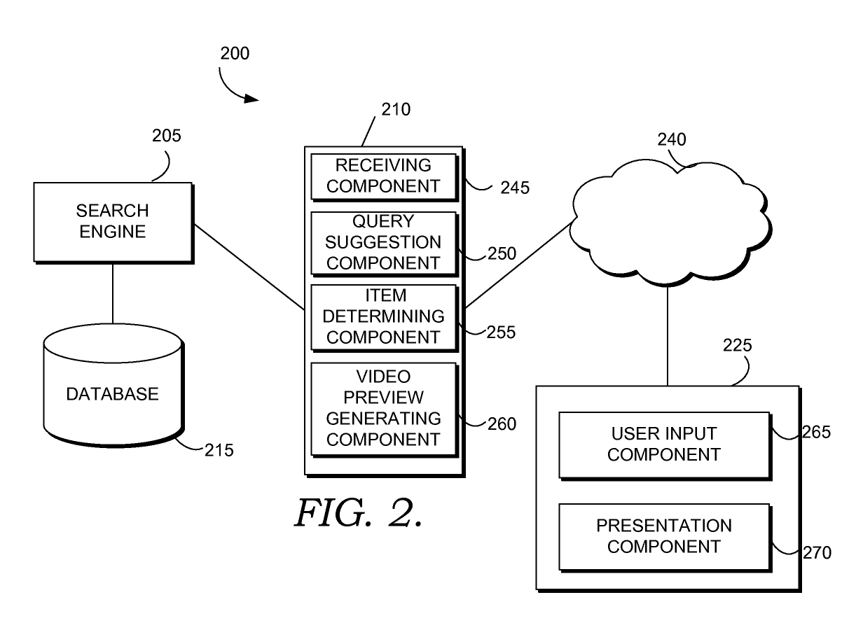

As previously set forth, embodiments of the present invention relate to computing systems and methods for displaying one or more image representations of video items or images for query suggestions to a user. With reference to FIG. 2, a block diagram is illustrated that shows an exemplary computing system architecture 200 configured for displaying one or more image representations of video items or images for one or more query suggestions, in accordance with an embodiment of the present invention. It will be understood and appreciated by those of skill in the art that the computing system architecture 200 shown in FIG. 2 is merely an example of one suitable computing system and is not intended to suggest any limitation as to the scope of use of functionality of the present invention. Neither should the computing system architecture 200 be interpreted as having any dependency or requirement related to any single module or component or combination of modules and components.

Computing system architecture 200 includes a search engine 205, query suggestion module 210, a storage device 215 and an end-user device 225. Search engine 205 and query suggestion module 210 is in communication with end user device 225 via a network 240. The network 240 may include, without limitation, one or more local area networks (LANs) and/or wide area networks (WANs). Such networking environments are commonplace in offices, enterprise-wide computer networks, intranets and the Internet. Accordingly, the network 240 is not further described herein. It will also be appreciated that search engine 205 and query suggestion module 210 may be in communication with one another or may be integrated into a single server or a combination of servers.

The storage device 215 is configured for storing received search queries, query based query suggestions, metadata and keywords related to particular consume products and services, user interface configuration templates, search index and the like. It will be appreciated that how modules and components discussed below access the storage device 215 to display image representations of video items for query suggestions may vary. In embodiments, the storage device 215 is configured to be searchable by the search engine 205. It will be appreciated by those of ordinary skill in the art that the information stored in the storage device 215 may be configurable and may include a variety of data for use by the query suggestion module 210.

Further, though illustrated as a single, independent component, the storage device 215 may, in fact, be a plurality of storage devices, for instance a database cluster, portions of which reside on a server, the end user device 225, another external computing device (not shown) and/or any combinations thereof. The storage device 215 may also be integrated into a single server or a combination of servers.

As shown in FIG. 2, query suggestion module 210 includes a receiving component 245, a suggestion determining component 250, an item determining component 255 and video preview generating component 260. Receiving component 245 is configured for receiving requests for information, for instance, a user request for presentation of a particular video, image search query, a user-input search query and the like. Upon receiving a request for information, the receiving component is configured for transmitting such a request, for instance, to search engine 205, upon which one or more video content items or images responding to the input request are returned. In one embodiment, search engine 205 parses the received search query into one or more search terms/phrases and compares the search term(s)/phrases(s) to a search index associated with a data store (for instance, data store 215). Video content items may include video clips, television programs, video segments and video streams corresponding to the input request. Search engine 205 determines a plurality of search result items, such as web pages having the requested video content or images, for the received search query. A listing of web pages containing video content items or images is returned in response to a search query. An image representation of one or more of the video content items or images is displayed to the user as described in more detail below. An image representation of a video content item may include a thumbnail or display of a static scene or image from a video content item, a video preview of the video content item, the image, or an associated static image (e.g., headshot of a celebrity, or picture of an animal for which the video content item is about).

Upon receiving the request for information, the receiving component is configured for also transmitting the request or search query to suggestion determining component 250. Suggestion determining component 250 is configured to receive the search query entered by a user and to determine query suggestions based upon the request or search query terms. A query suggestion is a possible search query or request that a user may choose to have performed. A query suggestion does not include search result items generated by the search engine that satisfy the original input query of the user but are possible other queries that the user may like to have performed that relate to the input query. Query suggestions may lead to something to which the user may be interested.

Suggestion determining component 250 is configured for determining at least one query suggestion based upon information input by a user, such as a search query. In one embodiment, the user request may be for presentation of a particular video, particular image or a user-input search query for videos or the like for a particular subject.

Keywords from the search query input may be utilized to develop one or more textual query suggestions. For example, a query search input by a user for video by a particular artist, may lead to query suggestions for videos for related artists. For example, a search query input by a user for Britney Spears videos may trigger the query suggestion of videos for related artists, such as Madonna and Christina Aguilera. Thus, textual based query suggestions for the search “Britney Spears video” may include “Madonna video” and “Christina Aguilera video.” One or more of the query suggestions are transmitted to video item determining component 255.

The item determining component 255 is configured for determining one or more search result items related (e.g., that satisfy) a query suggestion. Item determining component 255 transmits one or more of the query suggestions generated by the suggestion determining component 250 to search engine 205. The search engine 205 returns one or more web pages that satisfy a query suggestion. For example, the search engine 205 utilizes textual query suggestions of from the query suggestion component 250 to find web pages content items associated with one or more query suggestions. In embodiments, the search engine 205 parses the received search query suggestions into one or more search terms/phrases and compares the search term(s)/phrases(s) a search index associated with a data store (for instance, data store 215). The search is performed and the search result items typically include one or more listings of web pages having video content or images for the one or more search query suggestions. It will be appreciated that the search performed for one or more query suggestions may be a complete search or a partial search returning only a few results (e.g., 2-3 query suggestion result items).

Video preview generating component 260 is configured for generating a video preview of the video content items generated for the query suggestions. One skilled in the art will appreciate that any suitable method may be used to create such a preview, which is more fully described below. As used herein, a video preview is a video summarizing a video content item comprising one or more segments from the video content item, where the video preview provides the user with enough information about the video content item to allow the user to know if watching the entire video content item is desired. A video preview of a video content item may, for example, provide highlights of the video (e.g., by presenting part of each scene of the video). One skilled in the art will appreciate that the length of a video preview may vary as necessary. The representation may statically represent a scene of the total video item or the first segment of the video preview of the video item. Furthermore, in one embodiment, when executed by the appropriate user action, the video preview of only one video item representation will play at a time.

One skilled in the art will understand that the generation of a video preview may vary depending on the query suggestions. For example, if the video content item is a music video, the video preview may comprise fewer segments of a longer length in the preview, which allows the user to better hear and understand the music or song (e.g., three ten-second segments within the preview). Or, if the video content item is a movie trailer, for example, the video preview may be a continuous segment for the entire thirty second duration. In one embodiment, instead of performing a search and generating a preview, a stored or cached search results for query suggestions and associated image representations for the video content are accessed.

As shown in FIG. 2, the end-user device 225 includes a user input component 265 and a presentation component 270. In some embodiments, one or more of the components 265 and 270 may be implemented as stand-alone applications. In other embodiments, one or both of the components 265 and 270 may be integrated directly into the operating system of the end-user device 225. It will be understood by those of ordinary skill in the art that the components 265 and 270 illustrated in FIG. 2 are exemplary in nature and in number and should not be construed as limiting. Any number of modules may be employed to achieve the desired functionality within the scope of embodiments hereof.

User input component 265 is configured for receiving input of search query terms. Typically, search query terms are input via a user interface (not shown) associated with the end-user device, or the like. Upon receiving input of search query terms, the presentation component 270 of the end-user device 225 is configured for presenting video items for search result items and query suggestions determined by the search engine 205.

The presenting component 270 is configured for presenting a plurality of video content items and, in some embodiments, the web page in association with which the video content items are to be presented in response to the user input request for information (e.g., from receiving component 245). The presenting component 270 associated with the user device 225 is accordingly configured to receive the video content items and associated video representations of the query suggestions and for presenting (e.g., displaying) such video content items and representations to the user. The presenting component 270 of the user device 225 may present the representations, including previews, utilizing a variety of different user interface components, several of which are described more fully below.

Video previews may be presented in association with the corresponding video item upon presentation of the web page presented in response to the user request for information, may be presented only upon detection of particular user actions, or any combination thereof. Exemplary user actions may include, without limitation, a mouse over at least a portion of a video content item or representation of a video content item, a scrolling action with respect to a particular presented video content item, or a selection of a selectable portion of a video content item. Accordingly, each video preview can be dynamically executed or presented in response to the detected user action.

Additionally, the presenting component 270 may present control buttons in response to a user action. Such control buttons may appear with the execution of the video preview, and would allow the user the ability to control the video preview. Exemplary control buttons may allow the user to mute the video preview, save the video preview, and the like.

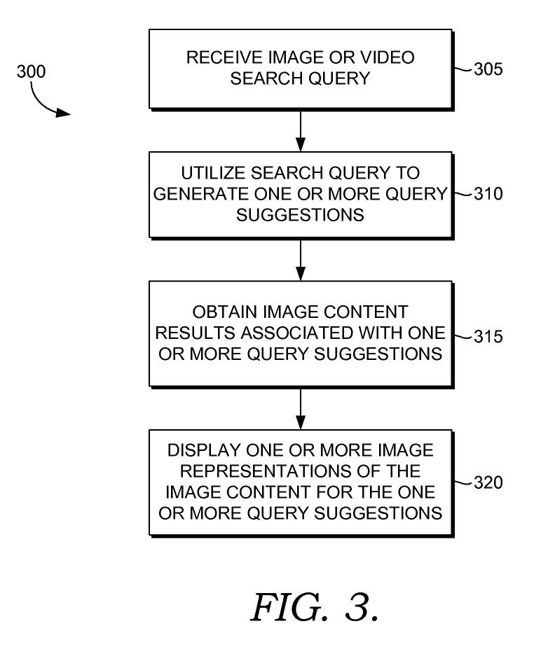

Turning now to FIG. 3, a flow diagram is illustrated which shows a method 300 for displaying video content items for query suggestions, in accordance with an embodiment of the present invention. Initially, as indicated at block 305, a request for user information is received, e.g., by utilizing receiving component 245 of FIG. 2. Subsequently, the user information is utilized to generate one or more query suggestions at block 310. At block 315, one or more video content items relevant to the query suggestions are obtained, as indicated at block 315. As previously described, search engine 205 of FIG. 2 may query data store 215 for the video content items relevant to one or more query suggestion.

Next, as indicated at block 320, representations of video content items are configured and displayed for one or more query suggestions. It will be understood that in some embodiments, the video content items may already have been configured as representations and indexed (e.g., in data store 215 in FIG. 2). In embodiments, the video preview associated with the video content item may also be configured prior to receiving a request from a user. The indexed or cached representation and video preview may then be accessed, for instance, from data store 215. It will be appreciated that the indexed or cached representation and query suggestion search results may have been cached and stored in response to a query from another user or popular query suggestions may be performed by the search engine 205 at regular intervals. The representations may, for example, be in the form of thumbnails and images and may statically show the first scene from the video content item, the first scene from a video preview of the video content item, or the like. If no user actions upon which presentation of the video previews is conditioned have been detected, each representation of the video content items will be presented without playing a video preview, for instance, utilizing presenting components of FIG. 2.

As previously described, exemplary user actions may include, without limitation, a mouse over at least a portion of a video content item or video representation associated therewith, a scrolling action with respect to the web page in association with which video content items are presented, a scrolling action with respect to a particular presented video content item, a selection of a selectable portion of a video content item, a mouse over a video preview indicator associated with one or more presented video representations (more fully described below), an election of a video preview indicator associated with one or more presented video representations, or any combination thereof.

If, however, one or more user actions upon which presentation of video previews is conditioned have been detected, a video preview is accessed and executed (for instance, utilizing video preview generating component 260 of FIG. 2), as indicated at block 320. The representations of the video content items are presented at block 320. It will be understood that, although block 320, the representations are presented simultaneous to the execution of the video preview. In other words, assuming more than one video content item is relevant to the search query, one preview may be executed upon the detection of a user action, while the representations associated with the other video content items are presented.

It will be understood by those of ordinary skill in the art that the order of steps shown in the method 300 of FIG. 3 are not meant to limit the scope of the present invention in any way and, in fact, the steps may occur in a variety of different sequences within embodiments hereof. For instance, the video previews may be created prior to determining if any user-driven conditions have been met. In such an embodiment, the video previews may be cached or otherwise hidden from presentation until such time as the user actions upon which presentation is conditioned are detected and/or determined. Any and all such variations, and any combinations thereof, are contemplated to be within the scope of embodiments of the present invention.

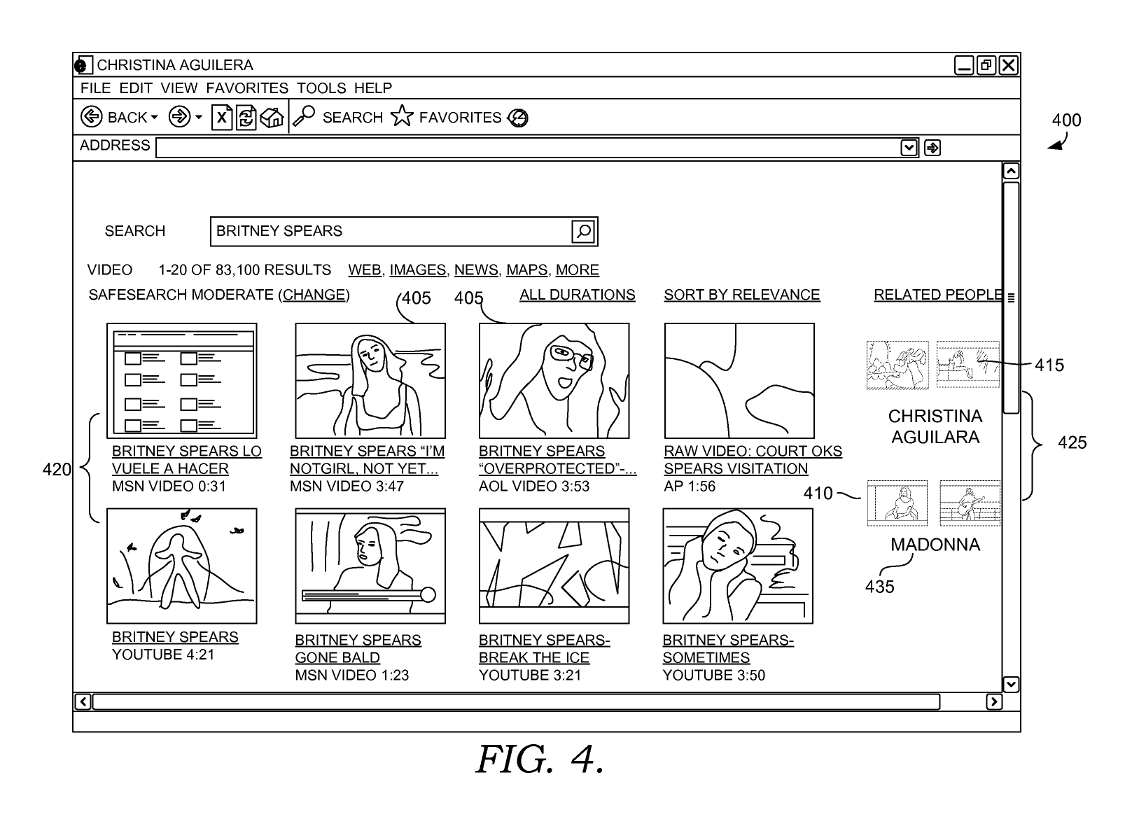

As previously mentioned, video representations and video previews may be presented utilizing a variety of user interface features. Such features may include, by way of example only, novel user interface elements presented with respect to a web (or other source) page, or executing video previews when a particular representation of a video content item is hovered over. Without limitation, a number of user interface features are described herein below with reference to FIGS. 4-7. It will be understood by those of ordinary skill in the art that a number of other user interface features may be utilized to execute and/or present video previews in accordance with embodiments hereof and that the user interface features shown in FIGS. 4-7 are meant to be merely illustrative of some such features.

With reference to FIG. 4, an illustrative screen display is shown, in accordance with an embodiment of the present invention, of an exemplary user interface 400 showing video representations related to the search result items 405 and video representations related to query suggestions 410 and 415. More particularly, the user interface 400 shown in FIG. 4 includes a video item query response representation display area 420 and a video item query suggestions representation display area 425. An example of a video item image representation for an original query response is shown at 405. The video item image representation 405 includes a video item image representation associated with the search result video item that was returned in response to the original search query, “Britney Spears”.

An example of video content image representations for query suggestions is shown at 410 and 415. Video item image representations for query suggestions include video item representations associated with query suggestions “Christina Aguilera” and “Madonna.” Query suggestions Christina Aguilera and Madonna were determined by query suggestion component 260 of FIG. 2. Search engine 205 of FIG. 2 then utilized textual query suggestions “Christina Aguilera” and “Madonna” find web pages (or the like) having video content for the query suggestions. The video item image representations 410 and 415 include a video item representation associated with the search result video item that was returned for query suggestions “Christina Aguilera” and “Madonna”. This allows a user to see visually the content of a video item rather than merely seeing textual link to query suggestion.

The video item image representations may be obtained from stored or cached video image representations or generated by video preview component 250. As shown in FIG. 4, two video item representations for each of the query suggestions “Christina Aguilera video” and “Madonna video” are displayed. It will be appreciated that any number of video item representations may be displayed for each query suggestion.

In embodiments, previews of the video content items are presented by presenting a representation of the video preview in association with a video content item but with the video preview appearing as a static video item representation until the user performs a particular action. This user interface feature is particularly useful as it permits the user to preview the video in the search results page without having to first select a video content item.

As previously set forth, detectable user actions may include, without limitation, a mouse over at least a portion of a video content item, a scrolling action with respect to the web page in association with which video content items are presented, a scrolling action with respect to a particular presented video representation, a selection of a selectable portion of a video content item, a mouse over a video representation associated with one or more presented video content items, or any combination thereof. This is shown in FIG. 4 by icon 430, which represents the location of the user action (e.g., mouse icon). As shown, icon 430 illustrates the user hovering over video representation 410.

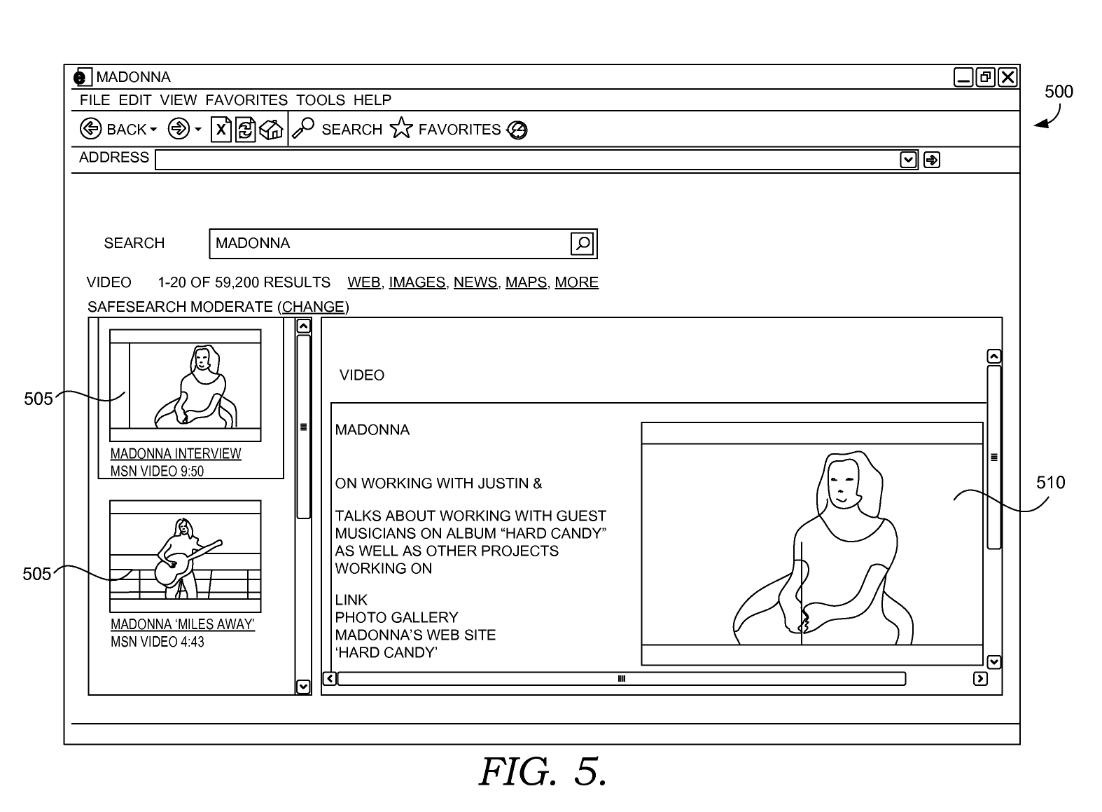

Selection or clicking a video item image representation of a query suggestion causes a new query search to be performed by search engine 205 of FIG. 2 and image representations of search results to be displayed. For example, with reference to FIG. 5, upon user selection of video item image representation 410 of FIG. 4, the search results 505 for the Madonna video query suggestion are accessed and displayed. User interface 500 includes a video item display area 510 for displaying video item content for selected query suggestion video image representation. In other words, display area 510 displays the full video content for the selected video image representation 410 of FIG. 4. Video content item 510 plays the entire video content item.

The additional search results in the form of video image representations 505 for the query suggestions of selected video image representation 410 of FIG. 4 are displayed. As in FIG. 4, the video item representations have the capability of dynamically executing or playing a video preview in response to a particular user action.

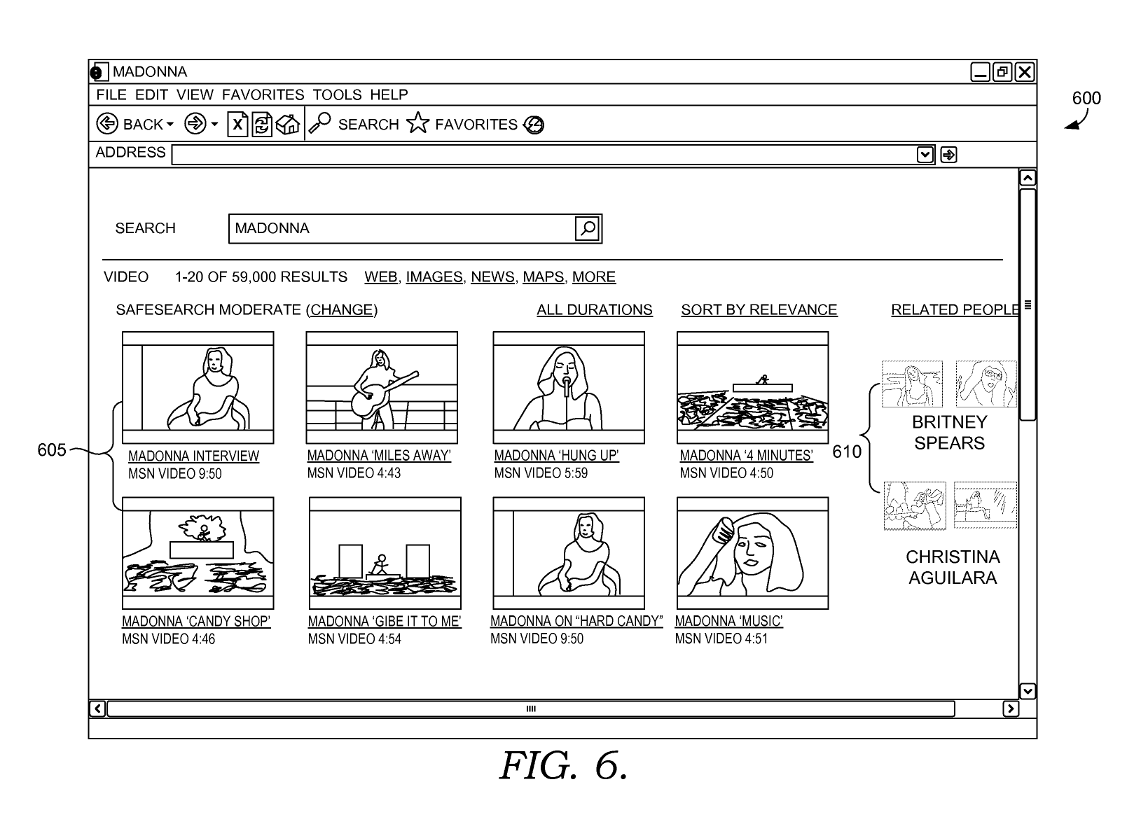

Referring next to FIGS. 4 and 6, textual information 435 may be displayed along with a video image representation 415 for search query suggestions. Selection or clicking the textual information 435 of a query suggestion causes a new query search to be performed by search engine 205 of FIG. 2 and image representations of search results to be displayed. For example, with reference to FIG. 6, upon user selection of video item image representation 435 of FIG. 4, the search results 605 for the Madonna video query suggestion are accessed and displayed. The search results for the selected text information selected are in the form of video image representations 605. Furthermore, when the search is performed for the selected query suggestion, new query suggestions and associate video image representations 610 are displayed for the search for the query suggestion. Thus, in this example, a search is performed or accessed for “Madonna videos” and the query suggestion module 210 of FIG. 2, determines that possible query suggestion for a search for “Madonna videos” are “Britney Spears videos” and Christina Aguilera videos.”As in FIGS. 4 and 5, the video item representations for the new query suggestions have the capability of dynamically executing or playing a video preview in response to a particular user action and may be selected for display of the full content and for a query search to be performed.

User interface features, such as those shown in FIGS. 4-6, may be implemented using various methods. By way of example, without limitation, the user interface may be implemented with support from a server to provide the relevant video content items. The video previews may be shown by embedding a control in the HTML page that is capable of executing or playing the preview in response to a particular user action. The interaction with these controls may be handled using JavaScript, Flash or Silverlight, which would allow the user to play, pause, or otherwise interact with the preview. Dynamic user interface components, such as representations that appear in response to a particular user action, can be handled using JavaScript, Flash or Silverlight, which may or may not contact a server to acquire additional information to provide necessary interactivity with the user.

When there are a large number of video content items on a page for which video previews may be desired, it may not be efficient to embed all of the video previews within the page. In this case, once a user performs a particular action that is a pre-condition to exposure and that indicates a video preview is desired for an individual video content item, an asynchronous request may be made to the hosting site for the video preview, which is then displayed dynamically. It will be understood by those of ordinary skill in the art that other implementations may be possible and that embodiments hereof are not intended to be limited to any particular implementation method or process.

Many different arrangements of the various components depicted, as well as components not shown, are possible without departing from the spirit and scope of the present invention. Embodiments of the present invention have been described with the intent to be illustrative rather than restrictive. Alternative embodiments will become apparent to those skilled in the art that do not depart from its scope. A skilled artisan may develop alternative means of implementing the aforementioned improvements without departing from the scope of the present invention.

It will be understood that certain features and subcombinations are of utility and may be employed without reference to other features and subcombinations and are contemplated within the scope of the claims. Not all steps listed in the various figures need be carried out in the specific order described.

The invention claimed is:

1. One or more computer-readable media having computer-executable instructions embodied thereon for performing a method for presenting video search results or images for query suggestions, the method comprising:
receiving a search query;
determining one or more query suggestions related the search query;
accessing one or more video items or images relevant to the one or more query suggestions; and
displaying an image representation for the one or more video items or images relevant to the one or more query suggestions to a user.

2. The computer readable media of claim 1, wherein the image representation comprises a video preview that is dynamically executed in response to one or more user actions.

3. The computer readable media of claim 2, wherein the image representation of each of the one or more video item users comprises a scene of the video item associated therewith.

4. The computer-readable media of claim 3, wherein the one or more user actions includes a mouse over at least a portion of one of the image representations of video items.

5. The computer-readable media of claim 4, wherein the image representation for the one or more video items comprises a static thumbnail image from the video item.

6. The computer-readable media of claim 5, wherein the selection of an image representation launches full content of the video item and a complete search for the selected query suggestion.

7. The computer-readable media of claim 6, further comprising:
displaying an image representation for the one or more video item search results from the complete search for the selected query suggestion.

8. The computer-readable media of claim 1, wherein accessing one or more video items relevant to the one or more query suggestions comprises accessing stored video items and image representations for the one or more query suggestions.

9. The computer-readable media of claim 1, wherein accessing the one or more video items relevant to the one or more query suggestions comprises performing a search for one or more search results containing video items and generating one or more video previews for the one or more search results.

10. The computer-readable media of claim 1, wherein a query suggestion is a possible search query or request that a user may choose to have performed.

11. The computer-readable media of claim 1, further comprising:
displaying a textual link to the one or more video items in addition to displaying an image representation of the one or more video items.

12. The computer-readable media of claim 11, wherein the image representation does not contain text.

13. One or more computer-readable media having computer-executable instructions embodied thereon for performing a method for presenting video search results for query suggestions, the method comprising:
receiving a search query input by a user;
determining one or more query suggestions related the search query;
performing a search for one or more web pages containing one or more video items relevant to the one or more query suggestions;
generating a video preview of the one or more video items that may be dynamically executed in response to one or more user actions;
displaying a static image of the video preview of the one or more video items relevant to the one or more query suggestions to the user;
receiving one or more user actions to dynamically execute the preview of the one or more video items; and
playing the preview of the one or more video items in response to the one or more user actions.

14. The computer-readable media of claim 13, wherein the one or more user actions includes a mouse over at least a portion of one of the image representations of video items.

15. The computer-readable media of claim 14, wherein the selection of a preview launches full content of the video item and a complete search for the selected query suggestion.

16. The computer-readable media of claim 15, further comprising:
displaying an image representation for the one or more video item search results from the complete search for the selected query suggestion.

17. The computer-readable media of claim 16, wherein a query suggestion is a possible search query or request that a user may choose to have performed.

18. The computer-readable media of claim 16, wherein the static image of the video preview does not contain text.

19. A user interface embodied on one or more computer-readable media for presenting video query suggestions in response to an input query, the user interface comprising:
a video item query response representation display area that displays a representation of each of one or more video items, wherein the one or more video items are search results in response to the input query and comprise a video preview, and wherein the video preview is dynamically executed within the video item representation display area in response to one or more user actions; and
a video item query suggestion representation display area that displays a representation of each of one or more video items for one or more query suggestions, wherein the one or more video items for one or more query suggestions comprise a video preview, and wherein the video preview is dynamically executed within the video item representation display area in response to one or more user actions.

20. The user interface of claim 19, wherein a query suggestion is a possible search query or request that a user may choose to have performed.
